(19) United States
(12) Patent Application Publication
(10) Pub. No.: US 2015/0111695 A1
(43) Pub. Date: Apr. 23, 2015

(54) CLUTCH MECHANISM, METHOD FOR THE OPERATION OF THE CLUTCH MECHANISM, AS WELL AS DRIVE TRAIN OF A MOTOR VEHICLE

(71) Applicant: GETRAG Getriebe- und Zahnradfabrik Hermann Hagenmeyer GmbH & Cie KG, Untergruppenbach (DE)

(72) Inventors: Wulf Leitermann, Murr (DE); Hansi Gremplini, Ingersheim (DE); Rafael Prellezo, Vaihingen/Enz (DE); Cedric Nuffer, Unterheinriet (DE)

(21) Appl. No.: 14/510,987

(22) Filed: Oct. 9, 2014

(30) Foreign Application Priority Data
Oct. 17, 2013 (DE) 10 2013 017 226.8

(51) Int. Cl. F16D 27/14; B60W 10/11; F16D 13/38; B60W 10/02

(52) U.S. Cl. CPC F16D 27/14; B60W 10/02; B60W 10/11; F16D 13/38
USPC 477/70

(57) ABSTRACT

A clutch mechanism which is arranged in a drive train between an internal combustion engine and a manual shift transmission of a motor vehicle. An input shaft is connected rotationally secured to the internal combustion engine and an output shaft is connected rotationally secured to the manual shift transmission. The input shaft is also connected rotationally secured to an input plate support and the output shaft is also connected rotationally secured to an output plate support. The input plate support supports input plates and the output plate support supports output plates. The input plates and the output plates can be charged and cooled with oil.

### CROSS-REFERENCE TO RELATED APPLICATIONS

This application claims priority of German patent application DE 10 2013 017 226, filed Oct. 17, 2013.

### BACKGROUND

The present invention relates to a clutch mechanism which is arranged in a drive train between an internal combustion engine and a manual shift transmission of a motor vehicle. The invention further relates to a method for the operation of the clutch mechanism, as well as to a drive train of a motor vehicle with the clutch mechanism and for the implementation of the method for the operation of the clutch mechanism.

Motor vehicles are driven by an internal combustion engine which transfers power by means of a drive train to a chassis frame. In the sense of the present invention, motor vehicles are to mean those motor vehicles which have four wheels and a permissible total weight of 12 tons in accordance with the EU Directive 2007/46/EU. One of the most important constituent parts of the drive train is the gearbox. Different types of gearboxes are known nowadays for use in motor vehicles. The type of gearbox most frequently selected for motor vehicles in Europe, India and China is the manual shift transmission. Compared with the automatic converter transmissions which are popular in the United States and Japan, the manual shift transmission is not only robust and reasonably priced, but also has a high degree of efficiency. Robustness in the sense of the present invention means insensitivity to temporary overload, faulty operation etc. The manual shift transmission is more reasonably priced, since its manufacturing costs only amount to 50% to 66% of those for an automatic transmission. With manual shift transmissions, the driver of a vehicle nowadays has five, six and more forward gears available. In addition, a reverse gear is available. The driver hereby selects a gear with a shift lever according to the speed and drive direction of the motor vehicle.

In order to change from one gear to the other, the driver has to interrupt a lock-up between the internal combustion engine and the manual shift transmission. For this reason the internal combustion engine is connected to the manual shift transmission via a clutch mechanism. Dry friction clutches are the prior art for manual shift transmissions. A pressure plate is connected rotationally secured to the internal combustion engine and a driven plate is connected rotationally secured to the manual shift transmission. By actuating a clutch pedal, the driver himself releases/clears a friction lock between the friction elements pressure plate and driven plate. A dry friction clutch of this kind is known from document DE 10222730 A1.

In the case of motor vehicles having an automatic transmission, however, a wet friction clutch is frequently used, in which plates are loaded with an oil as friction elements. A wet friction clutch of this kind is known from document DE 102004030660 A1.

In the direct comparison between the dry friction clutch and the wet friction clutch, the dry friction clutch is characterized by robustness, a reasonable price and a high degree of efficiency. The wet friction clutch however has better cooling of the friction elements. In the dry friction clutch the friction elements are cooled by air and in the wet friction clutch they are cooled by oil. Since air has a lower heat capacity than oil, in the case of the dry friction clutch there is the danger that with repeated permanent overloading, such as during a stop and go operation in traffic jams, the friction linings wear out as a result of the high thermal energy inputs.

### SUMMARY

It is therefore a first object of the present invention to avoid wear caused by high thermal energy inputs on the clutch mechanism of a motor vehicle having a manual shift transmission.

In the sense of the present invention, the driving dynamics of a motor vehicle mean the performance of the accelerated and non-accelerated masses in the motor vehicle, which can lead to vibrations which the driver regards as troublesome. These vibrations influence the driving performance of the motor vehicle such as the directional stability and the acceleration. The vibrations however also influence the driving comfort in the motor vehicle, since the vibrations spread out as structure-borne noise to the passenger cell of the motor vehicle. Finally the manner of the clutch actuation by the driver also has a bearing on the driving dynamics. Thus the driver can hold the friction elements for an unnecessarily long time and too frequently in the friction lock, or he can produce the friction lock too quickly at too much speed differences of the friction elements. A sub-optimal clutch actuation of this type by the driver increases both the fuel consumption and also the CO₂ emissions and reduces the range of the motor vehicle.

A further object of the present invention is to improve the driving dynamics of a motor vehicle having a manual shift transmission.

In the sense of the present invention, the required installation space of a drive train means the volume which is required for the drive train to transfer the force of the internal combustion engine to the chassis and thereby to fulfil the secondary conditions such as operational safety, robustness, cost favourability, driving dynamics and degree of efficiency. Certainly in the case of motor vehicles having a front transverse drive the installation space available for the drive train is often very tight.

The object of the present invention is moreover to reduce the installation space required for a drive train in a motor vehicle having a manual shift transmission.

And the present invention is concerned with the additional problem of further improving the operational safety of the motor vehicle having a manual shift transmission.

At least one of these objects is achieved according to the invention by the clutch mechanism of independent claim 1. The clutch mechanism is arranged in a drive train between an internal combustion engine and a manual shift transmission of a motor vehicle; an input shaft is connected rotationally secured to the internal combustion engine and an output shaft is connected rotationally secured to the manual shift transmission; the input shaft is connected rotationally secured to an input plate support and the output shaft is connected rotationally secured to an output plate support; the input plate support supports input plates and the output plate support supports output plates; and the input plates and the output plates can be loaded and cooled with oil.

The lock-up between the internal combustion engine and the manual shift transmission is interrupted by this clutch mechanism by means of a wet friction clutch. Since the oil cooling of the friction elements of the wet friction clutch is more efficient compared with the air cooling of the friction elements in the case of the dry friction clutch, the friction elements of the wet friction clutch can be designed with a lower mass compared with the dry friction clutch, which saves weight. It has emerged that, for a drive train with a predetermined torque, the clutch mechanism having a wet friction clutch has a mass reduced by around 33% compared with a clutch mechanism having a dry friction clutch, which in turn clearly reduces the mass inertia on the input shaft and on the output shaft and improves the driving dynamics of the motor vehicle.

This object is thus completely achieved. Advantageous designs and further developments of the invention are given in the dependent claims.

The input shaft is preferably connected rotationally secured to a driven plate; and the output plate support is arranged radially inside the driven plate.

The driven plate is arranged on the side of the clutch mechanism in the direction of a dual-mass flywheel. This nested arrangement of the driven plate and output plate support is space-saving.

A radially inner end of the input plate support is preferably connected rotationally secured to a rotary feedthrough; and the rotary feedthrough is mounted rotatable directly above or radially outside a hub fixed on the housing, or the rotary feedthrough is mounted rotatable directly above or radially outside the output shaft.

The oil for loading the input plates and the output plates is directed into the clutch mechanism through this rotary feedthrough which rotates with the inner plate support during operation of the clutch mechanism. The rotary feedthrough is either mounted rotatably directly above or radially outside the hub fixed on the housing, or it is mounted directly above or radially outside the output shaft. The mass of the clutch mechanism is reduced through the minimal mass of the rotary feedthrough.

A radially inner end of the input plate support is preferably connected rotationally secured to a rotary feedthrough; and the input plate support is arranged radially inside the output plate support.

Oil for cooling the input plates and the output plates is directed into the clutch mechanism through the rotary feedthrough which rotates with the inner plate support during operation of the clutch mechanism. The oil is then distributed to the input plates and output plates by the centrifugal force and by means of openings in the input plate support and in the output plate support, as well as by means of grooves in the input plates and the output plates from radially inside to radially outside. When the vehicle is stationary on a hill and the internal combustion engine is running, only the input plate support rotates with the input shaft, whilst the output plate support does not rotate. Such an operating situation arises when driving away uphill. In the case of an output plate support which is arranged radially inside the input plate support and is not rotating, this output plate support blocks the distribution of the oil which is generated by the centrifugal force, whereby the input plates run the risk of wearing down as a result of insufficient cooling. Arranging the input plate support radially inside the output plate support prevents wear on the clutch mechanism caused by high thermal energy inputs.

The input shaft is preferably connected rotationally secured to a driven plate; the driven plate is connected rotationally secured to a cage; and the output plate support is arranged radially inside the driven plate and the cage.

The cage is arranged on the side of the clutch mechanism in the direction of the manual shift transmission. This nested arrangement of the output plate support radially inside the driven plate and cage is also space-saving.

In one method for the operation of the clutch mechanism, the friction lock-up of the input plates and the output plates is cleared by means of a spring assembly and produced by means of a pump actuator arrangement (normally open); or the friction lock-up of the input plates and the output plates is produced by means of a spring assembly and cleared by means of a pump actuator arrangement (normally closed).

In this method the wet friction clutch of the clutch mechanism is moved into open and closed positions by means of a spring assembly and a pump actuator arrangement. The clutch mechanism can be operated both as a normally open or also as a normally closed wet friction clutch. With a normally open wet friction clutch, the friction lock-up of the input plates and the output plates is cleared by the spring assembly and is produced by the engaged pump actuator arrangement. The driver can in an emergency, if the pump actuator arrangement fails, still roll the vehicle into a safe parking position, since lock-up between the internal combustion engine and the manual shift transmission is interrupted. With a normally closed wet friction clutch the friction lock-up of the input plates and the output plates is generated by the spring assembly and only cleared by the engaged pump actuator arrangement, it works actively against the spring assembly. Thus if the driver has parked the motor vehicle in a parking position and the pump actuator arrangement is switched off, then the parked vehicle is automatically blocked against rolling away on the plane through the lock-up between the internal combustion engine and the manual shift transmission and with an engaged gear, and for security against rolling away on the plane the driver need no longer pull on the hand brake, and also no parking lock needs to be provided in the motor vehicle. The operational safety of the motor vehicle is improved in a different manner through these measures.

The clutch mechanism is preferably operated with a clutch pedal sensor; if the clutch pedal sensor detects a foot force acting on a clutch pedal, then a positive electric clutch pedal signal is emitted from the clutch pedal sensor; the positive electric clutch pedal signal is transmitted to a clutch control; for a positive electric clutch pedal signal the clutch control generates a negative electric actuator signal; the negative electric actuator signal is transmitted to an electric motor; and an oil pump is driven by the electric motor for a transmitted negative electric actuator signal so that the input plates and the output plates are not in the friction lock-up.

The electric motor is controlled with a negative electric actuator signal through this clutch mechanism. The clutch control generates this negative electric actuator signal if the clutch pedal sensor detects a foot force and issues a positive electric clutch pedal signal. It is thus the clutch control which clears the friction lock-up between the input plates and the output plates for a positive electric clutch pedal signal, it automatically disengages. For the driver, the clutch actuation is thus clearly simplified since the clutch control clears the friction lock-up faster and more effectively than the driver and improves the driving dynamics of the motor vehicle.

The clutch mechanism is preferably operated with a clutch pedal sensor; if the clutch pedal sensor does not detect any foot force acting on a clutch pedal then a negative electric clutch pedal signal is emitted by the clutch pedal sensor; the negative electric clutch pedal signal is transmitted to a clutch control; for a negative electric clutch pedal signal the clutch control generates a positive electric actuator signal; the positive electric actuator signal is transmitted to an electric motor; and an oil pump is driven by the electric motor for a transmitted positive electric actuator signal so that the input plates and the output plates are in friction lock-up.

An electric motor is controlled with a positive electric actuator signal through this clutch mechanism. Conversely to the negative electric actuator signal, the clutch control produces this positive electric actuator signal for a negative electric clutch pedal signal received by the clutch pedal sensor. For the driver, the clutch actuation is thus clearly simplified since, by actuating the clutch pedal, he or she no longer himself/herself produces the friction lock-up between the input plates and the output plates, but only provides a foot force which is detected by the clutch pedal sensor. It is thus the clutch control which produces the friction lock-up between the input plates and the output plates for a positive electric clutch pedal signal, it automatically engages. Since the clutch control produces the friction lock-up faster and more effectively than the driver, the driving dynamics of the motor vehicle are improved.

The clutch mechanism is preferably operated with an accelerator pedal sensor; if a foot force acting on an accelerator pedal is detected by the accelerator pedal sensor, then a positive electric accelerator pedal signal is emitted by the accelerator pedal sensor; the positive electric accelerator pedal signal is transmitted to a clutch control; the clutch control generates a positive electric actuator signal for a positive electric accelerator pedal signal; the positive electric actuator signal is transmitted to an electric motor; and an oil pump is driven by the electric motor for a transmitted positive electric actuator signal so that the input plates and the output plates are in friction lock-up.

The electric motor is controlled with a positive electric actuator signal through this clutch mechanism. The positive electric actuator signal is produced by the clutch control for a positive electric accelerator pedal signal received by an accelerator pedal sensor. It is thus the clutch control which produces the friction lock-up between the input plates and the output plates, for a positive electric accelerator pedal signal; it automatically engages. The driver need thus only actuate the accelerator pedal and provide a foot force which is detected by the clutch pedal sensor, and the clutch control produces the friction lock-up between the input plates and the output plates; it automatically engages. Since the clutch control produces the friction lock-up faster and more effectively than the driver, the driving dynamics of the motor vehicle are improved.

If a low gear of the manual shift transmission is engaged, then an oil pump is preferably driven for a positive electric actuator signal so that the input plates and the output plates are in friction lock-up and a force lock-up is formed between the internal combustion engine and the manual shift transmission, and the motor vehicle drives away.

Thus if a low gear of the manual shift transmission is engaged and the accelerator pedal depressed, the motor vehicle will automatically move away. It is the clutch control which automatically produces the friction lock-up between the input plates and the output plates for a positive electric accelerator pedal signal, and thus forms the force lock-up between the internal combustion engine and the manual shift transmissions and automatically moves the motor vehicle on. In the sense of the invention, a low gear stage means a low gear stage of the motor vehicle such that the motor vehicle can move away from stationary, normally this is the lowest and second lowest gear stage. This is an advantage particularly in stop and go operation in traffic jams since the driver now need no longer actuate the clutch pedal, which reduces both the fuel consumption and also the CO₂ emissions, and increases the range of the motor vehicle, which in turn improves the driving dynamics of the motor vehicle.

The clutch mechanism is preferably operated with an accelerator pedal sensor; if no foot force acting on an accelerator pedal is detected by the accelerator pedal sensor then a negative electric accelerator pedal signal is emitted by the accelerator pedal sensor; the negative electric accelerator pedal signal is transmitted to a clutch control; a negative electric actuator signal is produced by the clutch control for a negative electric accelerator pedal signal; the negative electric actuator signal is transmitted to an electric motor; and an oil pump is driven by the electric motor for a transmitted negative electric actuator signal, so that the input plates and the output plates are not in friction lock-up.

The electric motor is controlled with a negative electric actuator signal by this clutch mechanism. The negative electric actuator signal is produced by the clutch control for a negative electric accelerator pedal signal received by an accelerator pedal sensor. It is thus the clutch control which clears the friction lock-up between the input plates and the output plates for a negative electric accelerator pedal signal.

Preferably, if a gear of the manual shift transmission is engaged, the oil pump is driven for a negative electric actuator signal so that the input plates and the output plates are not in friction lock-up, and a force lock-up between the internal combustion engine and the manual shift transmission is broken and the motor vehicle coasts/sails.

Thus, if a gear of the manual shift transmission is engaged and the accelerator pedal is not actuated, the motor vehicle thus coasts idling. It is the clutch control which, for a negative electric accelerator pedal signal, automatically clears the friction lock-up between the input plates and the output plates and thus interrupts the force lock-up between the internal combustion engine and the manual shift transmission, and the motor vehicle coasts idling. During coasting operation the internal combustion engine is uncoupled from the drive train, thus only the input shaft rotates which increases the degree of efficiency of the motor vehicle, a measure through which the fuel consumption and the CO₂ emissions are reduced and the range of the motor vehicle is increased, all of which improves the driving dynamics of the motor vehicle.

The input plates and the output plates are preferably charged with a predefined amount of oil; by charging the input plates and the output plates with a predefined amount of oil, the slip speeds are set for a slip between the input plates and the output plates; and torsional vibrations are isolated by means of the slipping input plates and output plates.

Through this slipping operation of the clutch mechanism, the torsional vibrations which are caused by torque irregularities in the internal combustion engine and which spread out over the drive train to the passenger cell of the motor vehicle and are annoyingly felt there by the driver, are actively isolated, which improves the driving dynamics of the motor vehicle. This active isolation of the torsional vibrations is undertaken by the clutch control which charges the input plates and the output plates with a predefined amount of oil. In the case of motor vehicles having a manual shift transmission and dry friction clutch, such a slipping operation of the dry friction clutch is not possible since a corresponding clutch control is not present.

The features mentioned above and which are still to be explained below can be used not only in the respective combination given, but also in other combinations or on their own without departing from the scope of the present invention.

### BRIEF DESCRIPTION OF THE SEVERAL VIEWS OF THE DRAWING

The invention is illustrated by way of example in the drawings and will be explained in further detail in the description of the drawings. These show:

FIG. 1 a diagrammatic illustration of a drive train of a motor vehicle with an embodiment of a clutch mechanism according to one of FIGS. 2 to 6;

FIG. 2 a part of a first embodiment of a clutch mechanism;

FIG. 3 a part of a second embodiment of a clutch mechanism;

FIG. 4 a part of a third embodiment of a clutch mechanism;

FIG. 5 a part of a fourth embodiment of a clutch mechanism;

FIG. 6 a part of a fifth embodiment of a clutch mechanism;

FIG. 7 a view of a part of the drive train of a motor vehicle with an embodiment of the clutch mechanism according to one of FIGS. 2 to 6; and

FIG. 8 a diagrammatic illustration of a pump actuator arrangement of a clutch mechanism according to one of FIGS. 2 to 6.

### PREFERRED EMBODIMENTS

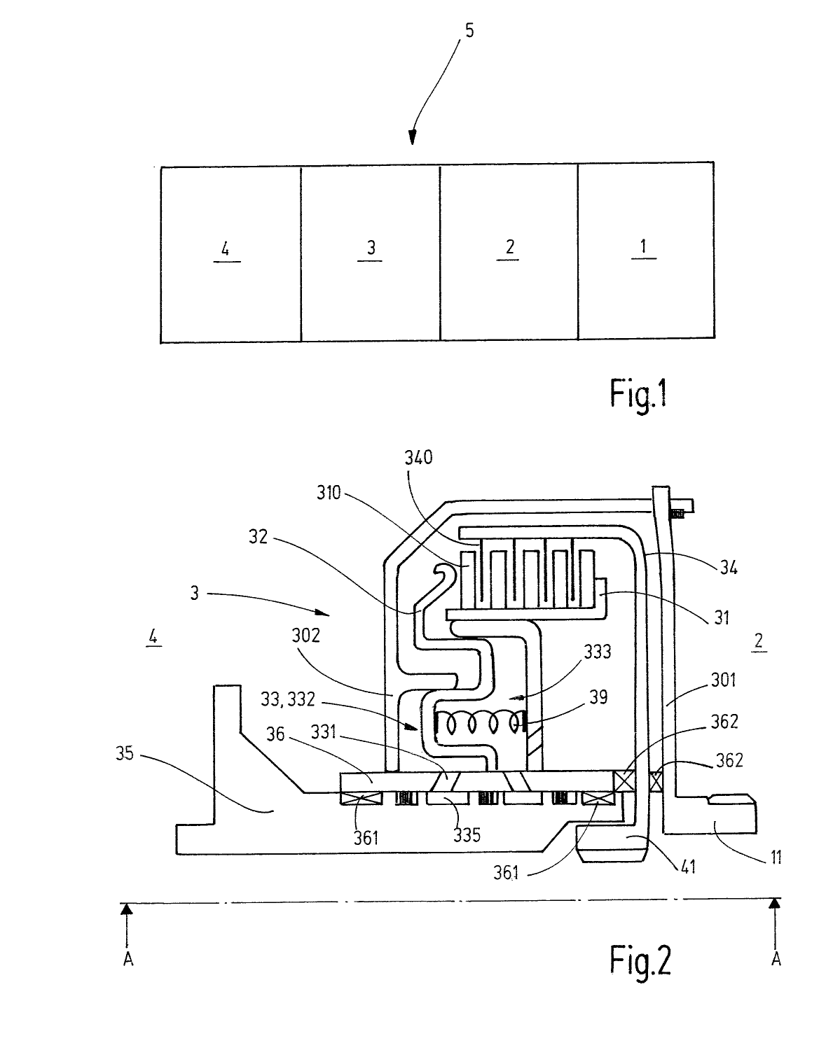

In the following descriptions of FIGS. 1 to 8 similar features are provided with the same reference numerals. Should there be serious differences between individual features, there will be an explicit reference thereto.

FIG. 1 shows a diagrammatic illustration of a drive train 5 of a motor vehicle having an internal combustion engine 1, a dual-mass flywheel 2, a clutch mechanism 3 and a manual shift transmission 4. The internal combustion engine 1 is connected rotationally secured to the dual-mass flywheel 2 and the clutch mechanism 3 by way of a crankshaft or input shaft 11. The dual-mass flywheel 2 reduces the torsional vibrations which are caused by torsional irregularities of the internal combustion engine 1 and which spread out via the drive train 5 to the passenger cell of the motor vehicle where they are perceived as troublesome by the driver. The clutch mechanism 3 is connected rotationally secured to the manual shift transmission 4 by way of an output shaft 41. FIG. 7 shows a view of a part of the drive train 5. With knowledge of the present invention, a person skilled in the art can also use an electric motor or a hybrid drive instead of an internal combustion engine.

The combustion engine 1, the dual-mass flywheel 2, the clutch mechanism 3 and the manual shift transmission 4 are designed with different masses and different installation spaces depending on the pre-set torque of the drive train 5. A combustion engine 1 with 750 Nm torque is thus heavier as regards mass and larger as regards installation space than an internal combustion engine 1 having 150 Nm torque, the same also applies for the dual-mass flywheel 2, the clutch mechanism 3 and the manual shift transmission 4, also here a dual-mass flywheel 2, a clutch mechanism 3 or a manual shift transmission 4 with 750 Nm torque is heavier as regards mass and larger as regards installation space than a dual-mass flywheel 2, a clutch mechanism 3 or a manual shift transmission 4 with 150 Nm torque. If for a predetermined torque, a clutch mechanism with a dry friction clutch is now compared with a clutch mechanism with a wet friction clutch, then the clutch mechanism with a dry friction clutch is heavier as regards mass and larger as regards installation space than a clutch mechanism with a wet friction clutch.

For a drive train 5 having a pre-set torque of 350 Nm a clutch mechanism with a dry friction clutch weighs around 6 kg, whilst the clutch mechanism 3 with a wet friction clutch only weighs around 4 kg, the reduction in the mass of the clutch mechanism 3 thus amounts to about 33%. For this drive train 5, the mass inertia on the input shaft 11 of the clutch mechanism 3 with a wet friction clutch amounts to around 10 gm², whilst the mass inertia on the input shaft of a clutch mechanism having a dry friction clutch amounts to around 75 gm², the reduction in the mass inertia on the input shaft 11 amounts to around 85%. For this drive train 5, the mass inertia on the output shaft 41 of the clutch mechanism 3 having a wet friction clutch amounts to around 2.6 gm², whilst the mass inertia on the output shaft of a clutch mechanism having a dry friction clutch amounts to around 6.4 gm², the reduction of the mass inertia on the output shaft 41 amounts to around 60%. For this drive train 5, the sum of the mass inertia of the input shaft 11 and output shaft 41 of the clutch mechanism 3 with a wet friction clutch amounts to around 13 gm², whilst the sum of the mass inertia of the input shaft and output shaft of a clutch mechanism with a dry friction clutch amounts to around 82 gm², the reduction of the sum of the mass inertia of the input shaft 11 and output shaft 41 amounts to around 85%. For this drive train 5, the installation space in the radial direction to the rotational axis A of the clutch mechanism 3 with a wet friction clutch has a diameter of around 180 mm, whilst the installation space in the radial direction to the rotational axis of a clutch mechanism with a dry friction clutch has a diameter of around 240 mm, the reduction in the installation space in the radial direction to the rotational axis amounts to around 25%. For this drive train 5, the installation space in the axial direction to the rotational axis A of the clutch mechanism 3 with a wet friction clutch amounts to around 100 mm, whilst the installation space in the axial direction to the rotational axis of a clutch mechanism with a dry friction clutch amounts to around 120 mm, the reduction of the installation space in the axial direction to the rotational axis amounts to around 20%. In the sense of the present invention, the percentage details are rounded to 5%.

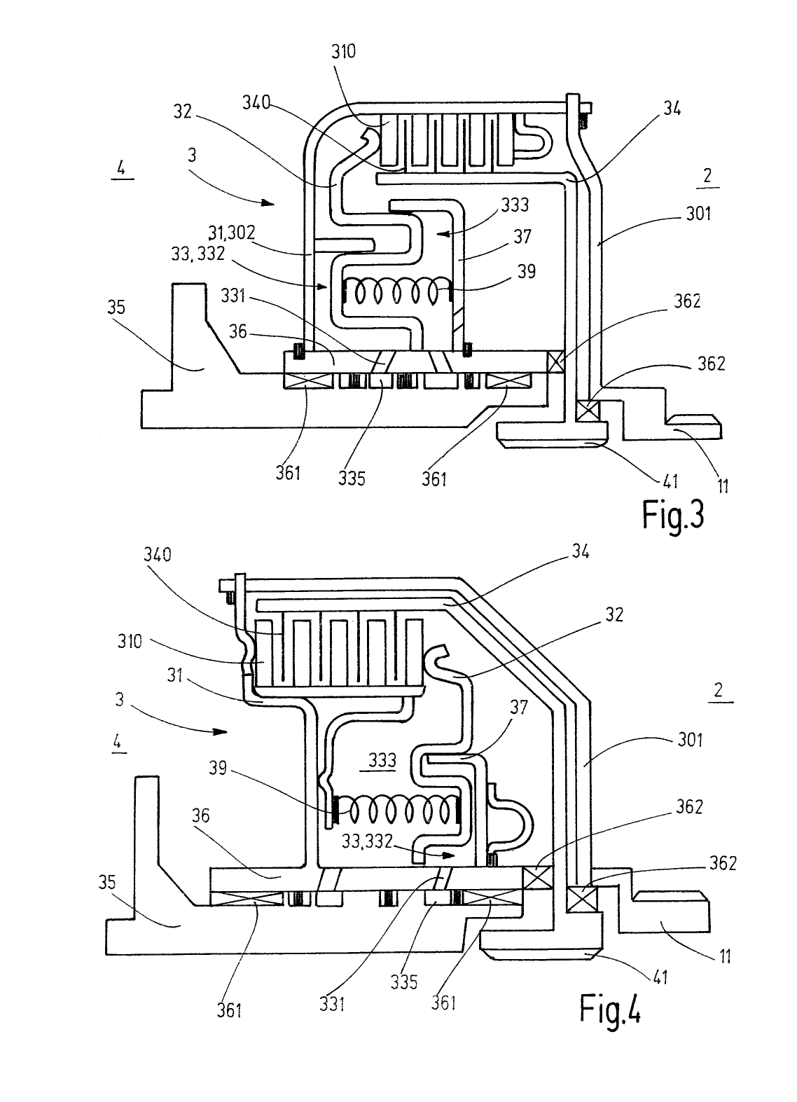

FIGS. 2 to 6 show parts of several embodiments of a clutch mechanism 3. Unless stated otherwise, the features of the drive train are of metal, such as steel, by way of example S420MC, HC300LA, HC340LA. The input shaft 11 is connected rotationally secured to a driven plate 301 of the clutch mechanism 3 by way of a spline according to DIN5480. According to the embodiments according to FIGS. 2 and 3, the driven plate 301 extends substantially in the radial direction to the rotational axis A. According to the embodiments according to FIGS. 4 and 5, the driven plate 301 extends in a radial and axial direction to the rotational axis A. According to the embodiments according to FIGS. 2 and 3, the driven plate 301 is connected rotationally secured to a radially outer end of a cage 302 by way of a circlip. The cage 302 extends cage-like axially and radially relative to the rotational axis A. The cage 302 is connected with a radially inner end rotationally secured to a rotary feedthrough 36. This connection can also be formed as a welded seam. According to the embodiments according to FIGS. 4, 5 and 6, the clutch mechanism 3 does not have a cage 302 and the driven plate 301 is connected rotationally secured to a radially outer end of an input plate support 31 by way of a welded seam.

According to the embodiments according to FIGS. 2 and 3, an output plate support 34 is arranged radially inside the driven plate 301 and the cage 302; and a piston 32 is arranged radially inside the cage 302. According to the embodiments according to FIGS. 4, 5 and 6 the output plate support 34 is arranged radially inside the driven plate 301; and the piston 32 is arranged radially inside the output plate support 34.

According to the embodiments according to FIGS. 2, 4, 5 and 6, the input plate support 31 is arranged radially inside the output plate support 34; according to the embodiment according to FIG. 3, the output plate support 34 is arranged radially inside the input plate support 31.

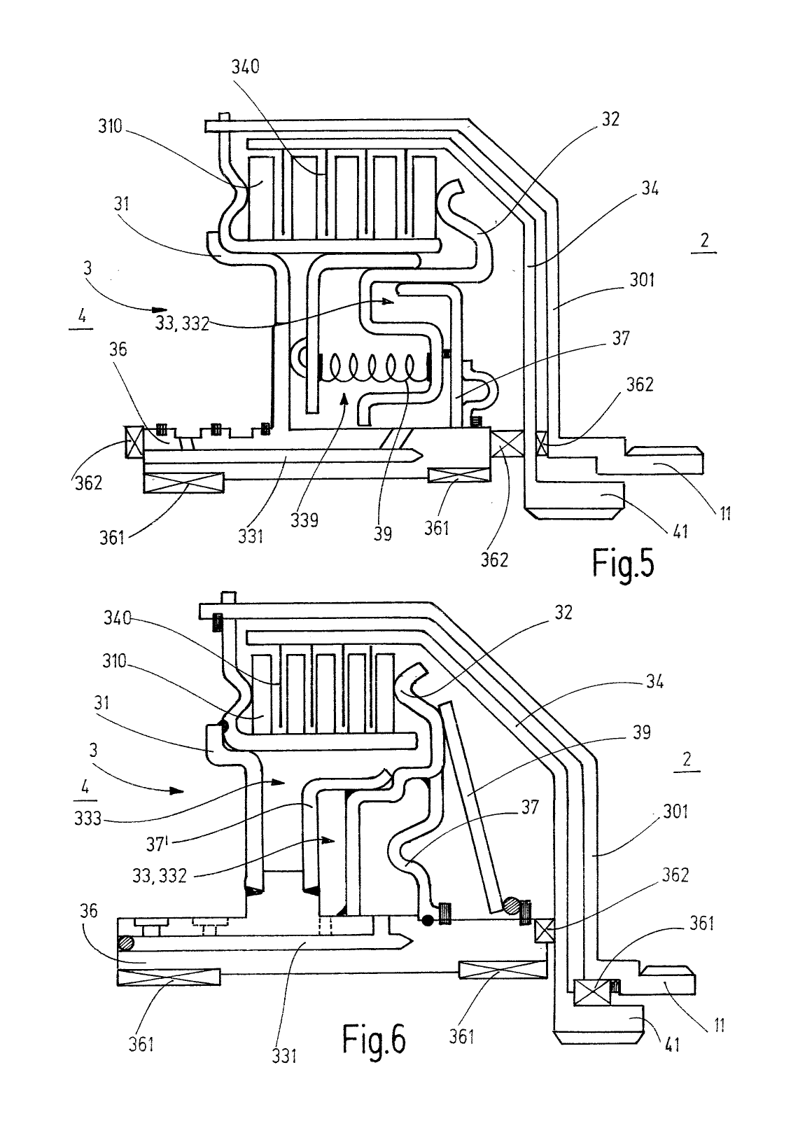

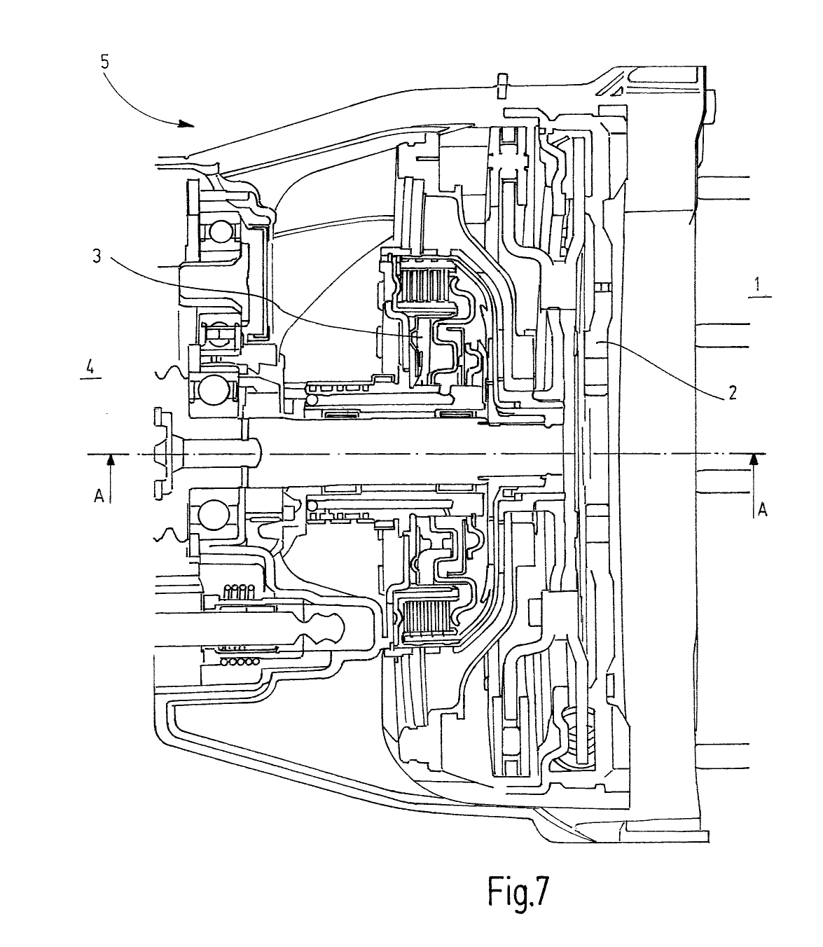

The rotary feedthrough 36 is designed substantially cylindrical and is arranged coaxial relative to the input shaft 11 and to the output shaft 41. According to the embodiments according to FIGS. 2, 3 and 4, the rotary feedthrough 36 is mounted rotatably via two radial bearings 361, such as needle bearings, directly above or radially outside a hub 35 which is fixed relative to a housing. According to the embodiments according to FIGS. 5 and 6 the rotary feedthrough 36 is mounted rotatable via two radial bearings 361 such as needle bearings directly above or radially outside the output shaft 41. The hub 35 is also designed to be substantially cylindrical and is arranged coaxial relative to the input shaft 11 and to the output shaft 41; it extends in the axial direction relative to the rotational axis A between the dual-mass flywheel 2 and the manual shift transmission 4.

A radially inner end of the input plate support 31 is connected rotationally secured to the rotary feedthrough 36. According to the embodiments according to FIGS. 2, 4 and 5, the input plate support 31 is T-shaped; according to the embodiment according to FIGS. 3 and 6, the input plate support 31 is L-shaped. The input plate support 31 extends substantially in the radial direction relative to the rotational axis A. The input plate support 31 supports several input plates 310. The input shaft 11 is thus connected rotationally secured to the input plate support 31 via the driven plate 301, cage 302 and rotary feedthrough 36. The output shaft 41 is connected rotationally secured to an output plate support 34. According to the embodiments according to FIGS. 2, 3 and 4, the output plate support 34 is mounted rotatable relative to the rotary feedthrough 36 and the driven plate 301 by way of axial bearings 362, such as needle bearings. According to the embodiments according to FIGS. 5 and 6, the output plate support 34 is mounted rotatably relative to the rotary feedthrough 36 by way of axial bearings 362, such as needle bearings. The output plate support 34 supports several output plates 340. The input plates 310 and the output plates 340 are arranged in a ring-fashion and coaxial relative to the input shaft 11 and to the output shaft 41. The plates consist of uncoated, thick steel plates and of thin steel plates coated with a friction lining, also called friction plates. The friction plates have a positive to neutral friction characteristic. In the figures steel plates are shown as rectangles whilst friction plates are shown as lines. The plates are arranged alternately in a row in the axial direction relative to the rotational axis A. Four friction plates are arranged between five steel plates, these nine plates of input plates 310 and output plates 340 make up one plate pack. The input plates 310 and output plates 340 can be brought into friction lock-up.

The piston 32 is in active connection with the plate pack. The piston 32 extends substantially in the radial direction relative to the rotational axis A. A radially inner end of the piston 32 loosely contacts the rotary feedthrough 36 and a radially outer end of the piston 32 can be pressed with a contact pressure against the plate pack. In the sense of the invention, loose contact means a mechanical contact in which there is no friction-locking, keyed locking, material-locking or force-locking connection. The piston 32 and rotary feedthrough 36 are thus arranged movable relative to one another. For this the piston 32 is mounted axially displaceably relative to the rotational axis A. The piston 32 is mounted in a single or double mode. According to the embodiment according to FIG. 2, the piston 32 is doubly mounted displaceably on the cage 302 and on the input plate support 31. According to the embodiment according to FIG. 3, the piston 32 is doubly mounted displaceably on the cage 302 and on a support 37. An inner end of the support 37 is connected rotationally secured to the rotary feedthrough 36, the support 37 is L-shaped. According to the embodiment according to FIG. 4, the piston 32 is singly mounted displaceably on the support 37. According to the embodiment according to FIG. 5, the piston 32 is doubly mounted displaceably on the input plate support 31 and on the support 37. According to the embodiment according to FIG. 6, the piston 32 is doubly mounted displaceably on two supports 37, 37′.

The clutch mechanism 3 can be designed either as a normally opened or as a normally closed wet friction clutch. In the case of a normally open wet friction clutch the plate pack is normally not in friction lock-up, since the piston 32 is spaced from the plate pack by means of a spring assembly 39 and can only be pressed against the plate pack by the oil 33 by means of a pump actuator arrangement 38. The clutch mechanism 3 according to the embodiments according to FIGS. 2, 3, 4 and 5 is normally open. Conversely in the case of a normally closed wet friction clutch the piston 32 is normally pressed against the plate pack by means of the spring assembly 39 and is spaced from the plate pack by means of the pump actuator arrangement 38. The clutch mechanism 3 according to the embodiment according to FIG. 6 is normally closed.

The following description of this section applies for a normally open wet friction clutch 3 according to the embodiments in FIGS. 2 to 5. When the plate pack is loaded with oil 33 the radially outer end of the piston 32 is displaced axially towards the plate pack and is pressed with the contact pressure force against the plate pack. According to the embodiments according to FIGS. 2 and 3, the piston 32 is pressed from the left side of the clutch mechanism 3 in the direction of the manual shift transmission 4 against the plate pack, according to the embodiments according to FIGS. 4 and 5, the piston 32 is pressed from the right side of the clutch mechanism 3 in the direction of the dual-mass flywheel 2 against the plate pack. The piston 32 is pretensioned with a mechanical spring force of the spring assembly 39 such as a helical compression spring. The spring assembly 39 is arranged in a centrifugal oil chamber 333. After the charge with oil 33 is finished, the piston 32 is moved axially away from the plate pack with the mechanical spring force.

The oil 33 is directed via an oil supply line 331 of the rotary feedthrough 36 into an oil chamber 332. According to the embodiments according to FIGS. 2, 3 and 4, the oil supply line 331 communicates with an oil groove 335 in the hub 35. The oil groove 335 communicates with an oil line 383 of a pump actuator arrangement 38 of the clutch mechanism 3. According to the embodiments according to FIGS. 5 and 6, the oil supply line 331 communicates directly with the oil line 383 of the pump actuator arrangement 38. The oil discharge line back into an oil reservoir 384 is not figuratively shown.

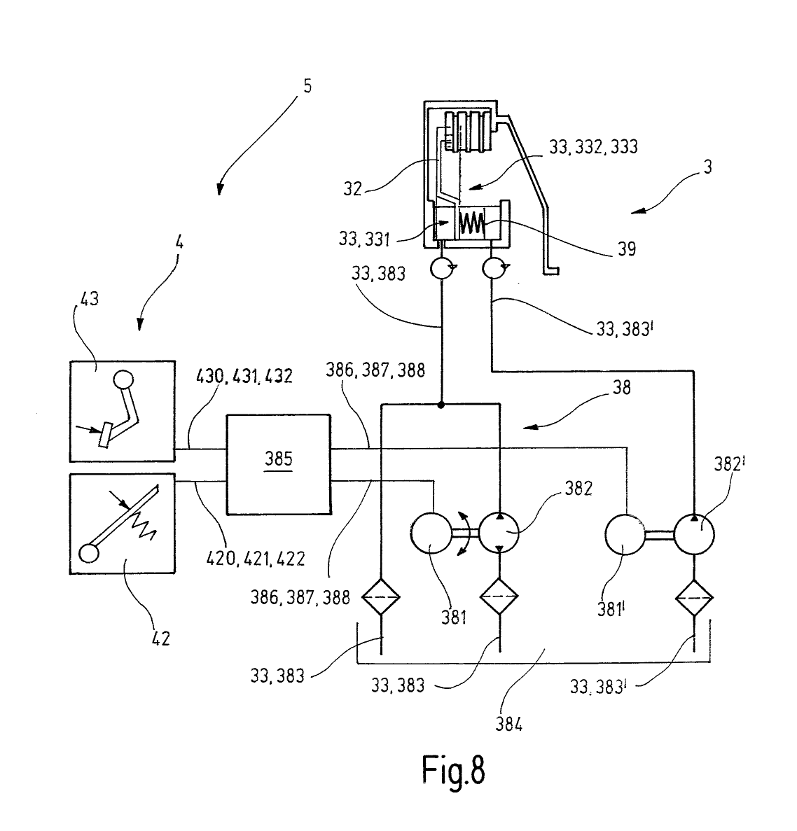

According to FIG. 8, the pump actuator arrangement 38 comprises two electric motors 381, 381′ and two oil pumps 382, 382′. An electric motor 381 and an oil pump 382 is provided for charging the plate pack with oil 33, i.e. for closing the clutch. A further electric motor 381′ and a further oil pump 382′ are provided for cooling the plate pack with oil 33. The oil pump 382 has two directions of rotation, the further oil pump 382′ has one direction of rotation. Through the further electric motor 381′ and the further oil pump 382′ which only cools the plate pack with oil 33, cooling can take place when best needed independently of the charging of the plate pack with oil 33 through the electric motor 381 and the oil pump 382. With knowledge of the present invention, the one skilled in the art can also provide only one electric motor 381 and one oil pump 382 for charging the plate pack with oil 33. Each pair of electric motors 381, 381′ and oil pumps 382, 382′ are in active connection with one another. A clutch control 385 of the clutch mechanism 3 controls and regulates the electric motor 381, 381′ with control and regulating signals which are transmitted from the clutch control 385 via an electric control lead 386 to the electric motor 381, 381′. For this purpose the clutch control 385 comprises a processor and a data memory. An algorithm is loaded from the data memory into the processor and is run. The algorithm run controls and regulates the electric motor 381, 381′, with control and regulating signals. With the activation of the electric motor 381, 381′ the electric motor 381, 381′ drives the oil pump 382, 382′ so that the oil pump 382, 382′ sucks in oil 33 from an oil line 383, 383′ or discharges oil 33 into the oil line 383, 383′. The oil line 383, 383′ communicates with the oil supply line 331. The oil 33 is pumped in this way to and fro between the oil reservoir 384 and the oil chamber 332.

The clutch control 385 is connected via an electric clutch pedal signal line 420 to a clutch pedal sensor 42 of a clutch pedal of the motor vehicle, and the clutch control 385 is connected via an electric accelerator pedal signal line 430 to an accelerator pedal sensor 43 of an accelerator pedal of the motor vehicle. With the knowledge of the present invention, the one skilled in the art can also provide only one electric clutch pedal signal line 420 between the clutch control 385 and the clutch pedal sensor 42 or also only one electric accelerator pedal signal line 430 between the clutch control 385 and the accelerator pedal sensor 43. As soon as the driver actuates the clutch pedal with a foot force, the clutch pedal sensor 42 emits an electric clutch pedal signal 421, 422 which is transmitted via the electric clutch pedal signal line 420 to the clutch control 385. The foot force acting on the clutch pedal is shown diagrammatically in FIG. 8 by an arrow. The clutch pedal sensor 420 detects by way of example an elastic deformation, caused by a foot force, of a mechanical spring attached to the clutch pedal. The mechanical spring is shown diagrammatically in FIG. 8. As soon as the elastic deformation of the mechanical spring exceeds a predetermined threshold value, a positive electric clutch pedal signal 421 is emitted by the clutch pedal sensor 420. Conversely, a negative electric clutch pedal signal 422 is emitted by the clutch pedal sensor 420 as soon as the driver reduces the foot force bearing on the clutch pedal to below the predetermined threshold value, in this case the term non-acting foot force is used in the sense of the invention. The clutch pedal sensor 420 preferably only releases a positive electric clutch pedal signal 421 and only a negative electric clutch pedal signal 422; it thus works in binary fashion. The accelerator pedal sensor 43 emits in a similar way an electric accelerator pedal signal 431, 432 which is transmitted via the second electric signal line 430 to the clutch control 385 as soon as the driver actuates the accelerator pedal with a foot force. The foot force acting on the accelerator pedal is also shown diagrammatically in FIG. 8 by an arrow. The accelerator pedal sensor 430 detects by way of example a rotation of a shaft caused by a foot force when the accelerator pedal is depressed. The accelerator pedal is attached rotationally secured on the shaft. The shaft is shown diagrammatically in FIG. 8. As soon as the rotation of the shaft exceeds a predetermined threshold value, a positive electric accelerator pedal signal 431 is emitted by the accelerator pedal sensor 430. Conversely, a negative electric accelerator pedal signal 432 is released by the accelerator pedal sensor 430 as soon as the driver reduces the foot force bearing on the accelerator pedal to below a predetermined threshold value, thus if there is no longer any foot force acting on the accelerator pedal. The accelerator pedal sensor 430 preferably emits a plurality of electric accelerator pedal signals 431, 432 for a plurality of different revolutions of the shaft, by way of example the accelerator pedal sensor 430 emits thirty phased electric accelerator pedal signals 431, 432 for thirty different rotated angular positions of the shaft. With knowledge of the present invention the one skilled in the art can use other sensors for detecting the foot force bearing on a clutch pedal or on an accelerator pedal.

For a positive electric clutch pedal signal 421 transmitted to the clutch control 385, the clutch control 385 generates a negative electric actuator signal 388 which is transmitted via the electric control line 386 from the clutch control 385 to the electric motor 381. For a negative electric clutch pedal signal 422 transmitted to the clutch control 385, the clutch control 385 generates a positive electric actuator signal 387 which is transmitted via the electric control line 386 from the clutch control 385 to the electric motor 381. For a positive electric accelerator pedal signal 431 transmitted to the clutch control 385, the clutch control 385 generates a positive electric actuator signal 387 which is transmitted via the electric control line 386 from the clutch control 385 to the electric motor 381. For a negative electric accelerator pedal signal 432 transmitted to the clutch control 385, the clutch control 385 generates a negative electric actuator signal 388 which is transmitted via the electric control line 386 from the clutch control 385 to the electric motor 381. For a positive electric actuator signal 387 transmitted to the electric motor 381, the electric motor 381 drives the oil pump 382 so that the input plates 310 and the output plates 340 are in friction lock-up. For a negative electric actuator signal 388 transmitted to the electric motor 381 the electric motor 381 drives the oil pump 382 so that the input plates 310 and the output plates 340 are not in friction lock-up.

For a drive train 5 with a predetermined torque of 350 Nm the clutch mechanism 3 has around 2-4 litres of oil 33, the plate pack is charged with a maximum pressure of around 12 bar in the oil chamber 332, the build-up of the maximum pressure in the oil chamber 332 requires around 100-200 msec and is significantly faster than the time interval required by the driver in order to actuate the clutch pedal or the accelerator pedal by foot force, in order thus to provide by the clutch pedal sensor 420 a clutch pedal signal 421, 422 or by the accelerator pedal sensor 430 an accelerator pedal signal 431, 432. These details given by way of example have a tolerance of plus/minus 10%.

The dual-mass flywheel 2 reduces torsional vibrations which arise through torsional irregularities in the internal combustion engine 1. Since the torsional vibrations in the drive train 5 appear resonance-like within a relatively large operating speed range, the dual-mass flywheel 2 has in most cases several spring stages and friction devices measured for different torque ranges. A dual-mass flywheel is thus comparatively expensive and is often liable to breakdowns. The clutch mechanism 3 is now used for the active vibration damping. For this the input plates 310 and the output plates 340 are operated in slip mode. For this the input plates 310 and the output plates 340 are charged with a predefined amount of oil 33 for a negative electric actuator signal 388 so that the input plates 310 and the output plates 340 slip relative to one another. Depending on the drive train 5 and the torque range of the internal combustion engine 1 such slip speeds are set by the predefined amount of oil 33 so that the torsional vibrations are isolated. Typical slip speeds amount to 10 to 100 min⁻¹. As a result of the positive to neutral friction characteristic of the friction plates, torsional vibrations can thus be reduced since, with a rising slip speed, the friction lock-up of the plate pack is also increased. Details on the predefined amounts of oil 33 are stored by way of example in a register in the data memory of the clutch control 385. These quantities of oil 33 are predefined for several torque ranges of the internal combustion engine 1 so that an optimum reduction of the torsional vibrations takes place. In which torque range the internal combustion engine 1 is momentarily located is imparted to the clutch control 385 via an electric control line, not shown in the figures, from a speed sensor, likewise not shown in the figures, by way of example the speed sensor transmits speed signals of the input shaft 41 to the clutch control 385 at regular time intervals. An algorithm of the clutch control 385 then calculates from the speed signals the momentary torque range of the internal combustion engine 1. Torsional vibrations both of the dual-mass flywheel 2 and also of the clutch mechanism 3 are thus reduced. This enables a space-saving and cost-effective design of the dual-mass flywheel 2, whereby for a drive train 5 with a predetermined torque, the clutch mechanism 3 with a wet friction clutch compared with a clutch mechanism with a dry friction clutch has a reduced installation space in the axial direction relative to the rotational axis A.

### LIST OF REFERENCE NUMERALS

A Rotational axis
1 Internal combustion engine
2 Dual mass flywheel
3 Clutch mechanism
4 Manual shift transmission
5 Drive train
11 Input shaft
31 Input plate support
32 Piston
33 Oil
34 Output plate support
35 Hub
36 Rotary feedthrough
37, 37′ Support
38 Pump actuator arrangement
39 Spring assembly
41 Output shaft
42 Clutch pedal sensor
43 Accelerator pedal sensor
301 Driven plate
302 Cage
310 Input plates
331 Oil supply line
332 Oil chamber
333 Oil centrifugal chamber
335 Oil groove
361 Radial bearing
362 Axial bearing
340 Output plates
381, 381′ Electric motor
382, 382′ Oil pump
383, 383′ Oil line
384 Oil reservoir
385 Clutch control
386 Electric control line
387 Positive electric actuator signal
388 Negative electric actuator signal
420 Electric clutch pedal signal line
421 Positive electric clutch pedal signal
422 Negative electric clutch pedal signal
430 Electric accelerator pedal signal line
431 Positive electric accelerator pedal signal line
432 Negative electric accelerator pedal signal

What is claimed is:

1. Clutch mechanism which is arranged in a drive train between an internal combustion engine and a manual shift transmission of a motor vehicle; with an input shaft which is connected rotationally secured to the internal combustion engine; with an output shaft which is connected rotationally secured to the manual shift transmission; wherein the input shaft is connected rotationally secured to an input plate support; wherein the output shaft is connected rotationally secured to an output plate support; wherein the input plate support supports input plates; wherein the output plate support supports output plates; and wherein the input plates and the output plates can be charged and cooled with oil.

2. Clutch mechanism according to claim 1, wherein the input shaft is connected rotationally secured to a driven plate; and wherein the output plate support is arranged radially inside the driven plate.

3. Clutch mechanism according to claim 2, wherein a radially inner end of the input plate support is connected rotationally secured to a rotary feedthrough; and wherein the rotary feedthrough is mounted rotatable directly above or radially outside a hub fixed on the housing or wherein the rotary feedthrough is mounted rotatable directly above or radially outside the output shaft.

4. Clutch mechanism according to claim 1, wherein a radially inner end of the input plate support is connected rotationally secured to a rotary feedthrough; and wherein the input plate support is arranged radially inside the output plate support.

5. Clutch mechanism according to claim 1, wherein the input shaft is connected rotationally secured to a driven plate; wherein the driven plate is connected rotationally secured to a cage; and wherein the output plate support is arranged radially inside the driven plate and the cage.

6. Clutch mechanism according to claim 5, wherein a radially inner end of the input plate support is connected rotationally secured to a rotary feedthrough; and wherein the rotary feedthrough is mounted rotatable directly above or radially outside a hub fixed on the housing.

7. Method for the operation of a clutch mechanism which is arranged in a drive train between an internal combustion engine and a manual shift transmission of a motor vehicle; with an input shaft which is connected rotationally secured to the internal combustion engine; with an output shaft which is connected rotationally secured to the manual shift transmission; wherein the input shaft is connected rotationally secured to an input plate support; wherein the output shaft is connected rotationally secured to an output plate support; wherein the input plate support supports input plates; wherein the output plate support supports output plates; and wherein the input plates and the output plates can be charged and cooled with oil, wherein a friction lock-up of the input plates and the output plates is cleared by means of a spring assembly and is produced by means of a pump actuator arrangement; or wherein a friction lock-up of the input plates and the output plates is produced by means of a spring assembly and is cleared by means of a pump actuator arrangement.

8. Method according to claim 7, wherein if a foot force acting on a clutch pedal is detected by a clutch pedal sensor, a positive electric clutch pedal signal is emitted by the clutch pedal sensor; wherein the positive electric clutch pedal signal is transmitted to a clutch control; wherein a negative electric actuator signal is generated by the clutch control for a positive electric clutch pedal signal; wherein the negative electric actuator signal is transmitted to an electric motor; and wherein an oil pump is driven by the electric motor for a transmitted negative electric actuator signal so that the input plates and the output plates are not in friction lock-up.

9. Method according to claim 8, wherein if the clutch pedal sensor does not detect any foot force acting on the clutch pedal, a negative electric clutch pedal signal is emitted by the clutch pedal sensor; wherein the negative electric clutch pedal signal is transmitted to the clutch control; wherein a positive electric actuator signal is generated by the clutch control for a negative electric clutch pedal signal; wherein the positive electric actuator signal is transmitted to the electric motor; and wherein the oil pump is driven by the electric motor for a transmitted positive electric actuator signal so that the input plates and the output plates are in friction lock-up.

10. Method according to claim 7, wherein if an accelerator pedal sensor does detect any foot force acting on an accelerator pedal, a positive electric accelerator pedal signal is issued by the accelerator pedal sensor; wherein the positive electric accelerator pedal signal is transmitted to a clutch control; wherein a positive electric actuator signal is generated by the clutch control for a positive electric accelerator pedal signal; wherein the positive electric actuator signal is transmitted to an electric motor; and wherein an oil pump is driven by the electric motor for a transmitted positive electric actuator signal so that the input plates and the output plates are in friction lock-up.

11. Method according to claim 10, wherein if a low gear stage of the manual shift transmission is engaged, for a transmitted positive electric actuator signal an oil pump is driven so that the input plates and the output plates are in friction lock-up and a force-locking engagement is formed between the internal combustion engine and the manual shift transmission and the motor vehicle moves off.

12. Method according to claim 10, wherein if the accelerator pedal sensor does not detect any foot force acting on the accelerator pedal, a negative electric accelerator pedal signal is emitted by the accelerator pedal sensor; wherein the negative electric accelerator pedal signal is transmitted to the clutch control; wherein a negative electric actuator signal is generated by the clutch control for a negative electric accelerator pedal signal; wherein the negative electric actuator signal is transmitted to the electric motor; and wherein the oil pump is driven by the electric motor for a transmitted negative electric actuator signal so that the input plates and the output plates are not in friction lock-up.

13. Method according to claim 12, wherein if a gear stage of the manual shift transmission is engaged, the oil pump is driven for a negative electric actuator signal so that the input plates and the output plates are not in friction lock-up and a force-locking engagement between the internal combustion engine and manual shift transmission is interrupted and the motor vehicle coasts.

14. Method according to claim 8, wherein the input plates and the output plates are charged with a predefined amount of oil; wherein through the charging of the input plates and the output plates with a predefined amount of oil, slip speeds are set for a slip between the input plates and the output plates; and wherein torsional vibrations are isolated by means of the slipping input plates and output plates.

15. Drive train of a motor vehicle having a clutch mechanism which is arranged in a drive train between an internal combustion engine and a manual shift transmission of a motor vehicle; with an input shaft which is connected rotationally secured to the internal combustion engine; with an output shaft which is connected rotationally secured to the manual shift transmission; wherein the input shaft is connected rotationally secured to an input plate support; wherein the output shaft is connected rotationally secured to an output plate support; wherein the input plate support supports input plates; wherein the output plate support supports output plates; and wherein the input plates and the output plates can be charged and cooled with oil, wherein a friction lock-up of the input plates and the output plates is produced by means of a spring assembly and is cleared by means of a pump actuator arrangement; or wherein a friction lock-up of the input plates and the output plates is cleared by means of a spring assembly and is produced by means of a pump actuator arrangement; wherein for a drive train with a predetermined torque, the clutch mechanism with a wet friction clutch has a mass reduced by around 33% compared to a clutch mechanism with a dry friction clutch.

16. Drive train according to claim 15, wherein for a drive train with predetermined torque, the clutch mechanism with a wet friction clutch in comparison with a clutch mechanism with a dry friction clutch has a mass inertia on the input shaft reduced by around 85%.

17. Drive train according to claim 15, wherein for a drive train with predetermined torque, the clutch mechanism with a wet friction clutch, in comparison with a clutch mechanism with a dry friction clutch, has a mass inertia on the output shaft which is reduced by around 60%.

18. Drive train according to claim 15, wherein for a drive train with a predetermined torque, the clutch mechanism with a wet friction clutch, in comparison with a clutch mechanism with a dry friction clutch, has a sum of the inertia of the input shaft and output shaft reduced by around 85%.

19. Drive train according to one of claim 15, wherein for a drive train with a predetermined torque, the clutch mechanism with a wet friction clutch, in comparison with a clutch mechanism with a dry friction clutch, has an installation space in the radial direction to the rotational axis reduced by around 25%.

20. Drive train according to claim 15, wherein for a drive train with a predetermined torque, the clutch mechanism with a wet friction clutch, in comparison with a clutch mechanism with a dry friction clutch, has an installation space in the axial direction relative to the rotational axis reduced by around 20%.
